(19) United States
(12) Patent Application Publication
(10) Pub. No.: US 2017/0032503 A1
(43) Pub. Date: Feb. 2, 2017

(54) SYSTEM AND METHOD FOR IMAGES DISTORTION CORRECTION

(71) Applicant: ISRAEL AEROSPACE INDUSTRIES LTD., Lod (IL)

(72) Inventors: Nadav RAICHMAN, Yakum (IL); Roni SCHWARTZ, Kfar Saba (IL); Hadas BAR-DAVID, Petach Tiqva (IL); Rotem LITTMAN, Hod Hasharon (IL); Udy DANINO, Bnei-Brak (IL); Noga ZIEBER, Tel Aviv (IL); Yaron GUROVICH, Rehovot (IL)

(73) Assignee: ISRAEL AEROSPACE INDUSTRIES LTD., Lod (IL)

(21) Appl. No.: 15/129,545

(22) PCT Filed: Mar. 29, 2015
(86) PCT No.: PCT/IL2015/050332

§ 371 Date: Sep. 27, 2016

(30) Foreign Application Priority Data
Mar. 31, 2014 (IL) 231818

(51) Int. Cl. G06T 5/00; G06T 7/00; G06T 5/50; G06T 3/00

(52) U.S. Cl. CPC G06T 5/006; G06T 3/0093; G06T 7/0081; G06T 7/0097; G06T 5/50; G06T 3/0068; G06T 7/0032

(57) ABSTRACT

Images are processed to compensate for rolling shutter effects. A pair of images are registered. A set of pixel rows in the first image and a corresponding set of pixel rows in the second image are obtained. A parametric model is generated characterizing a transformation between pixels in the set of pixel rows in the first image with pixels in the corresponding set of pixel rows of the second image. Using the generated parametric model, the set of pixel rows in the second image is warped with respect to the set of pixel rows in the first image, reducing rolling shutter effects.

### FIELD OF THE PRESENTLY DISCLOSED SUBJECT MATTER

This invention relates to the field of image processing. More specifically it relates to compensating for effects related to image sensors.

### BACKGROUND

Digital cameras employ one or a plurality of sensors. These include charge-coupled device (CCD) sensors and complimentary metal-oxide semiconductor (CMOS) sensors. In general a pixel on a digital camera can be configured such that it will collect photons when it is exposed. The photons can be converted to electrical charge by a photodiode.

Both CCD and CMOS image sensors can be prone to digital artifacts. Digital artifacts can arise due to the sensor, the associated optical, the internal image processing, and/or other parts of a system configured to capture images. Artifacts can arise during the course of the image capture and processing, for example at the temporal point where the image sensor captures the image, where the image sensor compresses the image, where the image sensor processes the image, among other temporal situations.

In some instances, digital artifacts are the result of hardware and/or software failures. For example, artifacts can include: (i) blooming—when a charge from a first pixel overflows into surrounding pixels clipping and or overexposing them, (ii) jaggies—i.e., visible jagged edges of otherwise smooth surfaces under low resolution, (iii) chromatic aberrations—i.e., wherein the optics fails to optimally focus different wavelengths of light resulting, in some instances in color fringing around contrasting edges, (iv) maze artifacts, (v) texture corruption, (vi) moiré—for example when a an image contains repetitive detail that outstrips the camera's resolution, (vii) random noise including sensor noise or stuck pixel noise, (viii) T-vertices in 3D graphics for example, occurring during occur during mesh refinement or mesh simplification, (ix) sharpening halos, (x) pixelization in MPEG compressed video, wherein image resolution is altered to seem, for example, that the image has been partially censored, and, (xi) white balance errors.

A further artifact, limited to CMOS sensors is that of a rolling shutter. CCD sensors can employ a global shutter wherein the entire sensor can be exposed by a camera shutter at the same time. CMOS sensors in particular can be prone to a rolling shutter effect wherein different parts of a sensor are exposed at different points in time.

CMOS sensors can be configured such that area of the CMOS sensor is sequentially or otherwise scanned by the shutter wherein an image captured at a top of a CMOS sensor can represent a different point in time from the image captured at a bottom of the CMOS sensor.

Shutter effects can be seen, in some examples during fast camera pans and/or fast movements of objects in front of the camera. This can be in instances where this movement of the camera and/or and object in front of the camera is faster than a frame rate and/or shutter speed of the camera. Shutter effects can be more pronounced in instances where a scene in a video includes strong vertical lines, including for example, propeller blades, wagon wheels, cranks, car undersides, and/or brief pulses of light. This can result in a jello effect, image wobble, skewing and/or smearing of the image, partial exposure and other potential errors that might offend a viewer through a cumulative effect of a lack of persistence of vision

### GENERAL DESCRIPTION

According to one aspect of the presently disclosed subject matter there is provided a method of processing images in a registered pair of images stored in a memory, each image comprising rows, the method comprising using a processor operatively coupled to the memory for obtaining at least one set of a plurality of pixel rows in a first image and a corresponding at least one set of a plurality of pixel rows in a second image, generating a parametric model characterizing a transformation between pixels in the at least one set of the plurality of pixel rows in the first image with pixels in the corresponding at least one set of a plurality of pixel rows of the second image, and warping the set of the plurality of pixel rows in the second image with respect to the set of the plurality of pixel rows in the first image using the generated parametric model, thereby compensating for distortions between the corresponding sets of the pluralities of pixel rows.

Furthermore, in accordance with some embodiments of the present invention, the method further comprising using the processor to divide each image in the registered pair of images into pairs of corresponding overlapping sets, each set comprising a plurality of pixel rows.

Furthermore, in accordance with some embodiments of the present invention, the method further comprising using the processor for generating, for each pair of corresponding overlapping sets, a parametric model characterizing a transformation between pixels in the corresponding sets; and for warping each set of pixel rows in the second image with respect to a corresponding set of pixel rows in the first image using a respective generated parametric model, thereby compensating for distortions between the registered pair of images.

Furthermore, in accordance with some embodiments of the present invention, the method further comprising using the processor to divide each image in the registered pair of images into pairs of corresponding overlapping sets, each set comprising a plurality of pixel rows based on parameters related to a device which captured said pairs of images.

Furthermore, in accordance with some embodiments of the present invention, the method further comprising further using the processor to smoothly interpolate one or more of the corresponding overlapping sets.

Furthermore, in accordance with some embodiments of the present invention, the method further comprising using the processor to apply a temporal filter to each pixel in the warped set of the plurality of pixel rows.

Furthermore, in accordance with some embodiments of the present invention, the method further comprising using the processor for registering the pair of images, wherein registering the pair of images comprises dividing the first image into a grid of equally sized bins and registering each equally sized bin separately with its corresponding bin in a similarly divided second image.

Furthermore, in accordance with some embodiments of the present invention, the method further comprising using the processor for registering each bin separately, by, for each bin and its corresponding bin, detecting and matching corners and features and rejecting local outliers.

Furthermore, in accordance with some embodiments of the present invention, the method further comprising generating a parametric model characterizing a transformation between pixels wherein generating includes generating a rolling homography estimation.

Furthermore, in accordance with some embodiments of the present invention, the method further comprising wherein non-informative transformations are filtered out.

There is further provided, in accordance with some embodiments of the present invention, a non-transitory computer-readable media storing computer-readable instructions that, when executed by a processor operatively coupled to a media, cause the processor to process images in a registered pair of images stored in a memory, each image comprising rows, to obtain at least one set comprising a plurality of pixel rows in a first image and a corresponding at least one set comprising a plurality of pixel rows in a second image, to generate a parametric model characterizing a transformation between pixels in the at least one set of the plurality of pixel rows in the first image with pixels in the corresponding at least one set of a plurality of pixel rows of the second image, and to warp the set comprising a plurality of pixel rows in the second image with respect to the set comprising a plurality of pixel rows in the first image using the generated parametric model, thereby compensating for distortions between the corresponding sets of the pixel rows.

Furthermore, in accordance with some embodiments of the present invention, the non-transitory computer-readable media storing computer-readable instructions further causing the processor to divide each image in the registered pair of images into pairs of corresponding overlapping sets, each set comprising a plurality of pixel rows.

Furthermore, in accordance with some embodiments of the present invention, the non-transitory computer-readable media storing computer-readable instructions further causing the processor to generate, for each pair of corresponding overlapping sets, a parametric model characterizing a transformation between pixels in the corresponding sets; and for warping each set of pixel rows in the second image with respect to a corresponding set of pixel rows in the first image using a respective generated parametric model, thereby compensating for distortions between the registered pair of images.

Furthermore, in accordance with some embodiments of the present invention, the non-transitory computer-readable media storing computer-readable instructions further causing the processor to divide each image in the registered pair of images into pairs of corresponding overlapping sets, each set comprising a plurality of pixel rows based on parameters related to a device which captured said pairs of images.

Furthermore, in accordance with some embodiments of the present invention, the non-transitory computer-readable media storing computer-readable instructions further causing the processor to smoothly interpolate one or more of the corresponding overlapping sets.

Furthermore, in accordance with some embodiments of the present invention, the non-transitory computer-readable media storing computer-readable instructions further causing the processor to apply a temporal filter to each pixel in the warped set of the plurality of pixel rows.

Furthermore, in accordance with some embodiments of the present invention, the non-transitory computer-readable media storing computer-readable instructions further causing the processor to register the pair of images, wherein registering the pair of images comprises dividing the first image into a grid of equally sized bins and registering each equally sized bin separately with its corresponding bin in a similarly divided second image.

Furthermore, in accordance with some embodiments of the present invention, the non-transitory computer-readable media storing computer-readable instructions further causing the processor to register each bin separately, by, for each bin and its corresponding bin, detecting and matching corners and features and rejecting local outliers.

Furthermore, in accordance with some embodiments of the present invention, the non-transitory computer-readable media storing computer-readable instructions further causing the processor to generate a parametric model characterizing a transformation between pixels that includes a rolling homography estimation.

Furthermore, in accordance with some embodiments of the present invention, the non-transitory computer-readable media storing computer-readable instructions further causing the processor to filter out non-informative transformations.

There is further provided, in accordance with some embodiments of the present invention, a system capable of processing a registered set of images comprising rows of pixels, the system comprising a processor operatively coupled to a memory, the processor configured to process images in a registered pair of images stored in a memory, each image comprising rows, to obtain at least one set comprising a plurality of pixel rows in a first image and a corresponding at least one set comprising a plurality of pixel rows in a second image, to generate a parametric model characterizing a transformation between pixels in the at least one set of the plurality of pixel rows in the first image with pixels in the corresponding at least one set of a plurality of pixel rows of the second image, and to warp the set comprising a plurality of pixel rows in the second image with respect to the set comprising a plurality of pixel rows in the first image using the generated parametric model, thereby compensating for distortions between the corresponding sets of the pixel rows.

Furthermore, in accordance with some embodiments of the present invention, the system wherein the processor is further capable of dividing each image in the registered pair of images into pairs of corresponding overlapping sets, each set comprising a plurality of pixel rows.

Furthermore, in accordance with some embodiments of the present invention, the system wherein the processor is further capable of, for each pair of corresponding overlapping sets, generating a parametric model characterizing a transformation between pixels in the corresponding sets and warping each set of pixel rows in the second image with respect to a corresponding set of pixel rows in the first image using a respective generated parametric model, thereby compensating for distortions between the registered pair of images.

Furthermore, in accordance with some embodiments of the present invention, the system wherein the processor is further capable of dividing each image in the registered pair of images into pairs of corresponding overlapping sets, each set comprising a plurality of pixel rows based on parameters related to a device which captured said pairs of images.

Furthermore, in accordance with some embodiments of the present invention, the system wherein the processor is further capable of smoothly interpolating one or more of the corresponding overlapping sets.

Furthermore, in accordance with some embodiments of the present invention, the system wherein the processor is further capable of applying a temporal filter to each pixel in the warped set of the plurality of pixel rows.

Furthermore, in accordance with some embodiments of the present invention, the system wherein the processor is further capable of registering the set of images, wherein registering the set of images comprises dividing the first image into a grid of equally sized bins and registering each equally sized bin separately with its corresponding bin in a similarly divided second image.

Furthermore, in accordance with some embodiments of the present invention, the system wherein the processor is further capable of registering each bin separately, by, for each bin and its corresponding bin, detecting and matching corners and features and rejecting local outliers.

Furthermore, in accordance with some embodiments of the present invention, the system wherein the processor is further capable of generating a parametric model characterizing a transformation between pixels including generating a rolling homography estimation.

Furthermore, in accordance with some embodiments of the present invention, the system wherein the processor is further capable of filtering out non-informative transformations.

There is further provided, in accordance with some embodiments of the present invention, a method of compensating a rolling shutter effects in a plurality of images, the method comprising using a processor operatively coupled to a memory to register a pair of images from the plurality of images stored in the memory, each image comprising rows, to obtain at least one set comprising a plurality of pixel rows in a first image and a corresponding at least one set comprising a plurality of pixel rows in a second image, to generate a parametric model characterizing a transformation between pixels in the at least one set of the plurality of pixel rows in the first image with pixels in the corresponding at least one set of a plurality of pixel rows of the second image and, to warp the set comprising a plurality of pixel rows in the second image with respect to the set comprising a plurality of pixel rows in the first image using the generated parametric model, thereby compensating for distortions between the corresponding sets of the pixel rows and, compensate for distortions between the corresponding set of a plurality of pixel rows, and thereby reducing one or more rolling shutter effects.

### BRIEF DESCRIPTION OF THE DRAWINGS

In the drawings and descriptions set forth, identical reference numerals indicate those components that are common in different drawings.

Elements in the drawings are not necessarily drawn to scale. It should be noted that the Figures are given as examples only and in no way limit the scope of the invention. Like components are denoted by like reference numerals.

For example, the dimensions of some of the elements may be exaggerated relative to other elements for clarity. Further, where considered appropriate, reference numerals may be repeated among the figures to indicate corresponding or analogous elements.

In order to understand the presently disclosed subject matter and to see how it may be carried out in practice, the subject matter will now be described, by way of non-limiting examples only, with reference to the accompanying drawings, in which:

FIG. 1 is a schematic of a device with an image sensor, according to an example;

FIG. 2A is a flowchart illustrating a method image distortion correction, according to an example;

FIG. 2B is a flowchart illustrating a method for image distortion correction, including rolling shutter, according to an example.

FIG. 3A depicts a matching between two images for image distortion correction, according to an example;

FIG. 3B depicts a flowchart describing matching between two images, for image distortion correction, according to an example;

FIG. 4A is a depiction of a smoothing of hymnographies, for use in a method for image distortion correction, according to an example

FIG. 4B is a depiction of the distribution for homography parameters for a simulated rolling shutter prior to Gaussian smoothing between blocks for use in a method for image distortion correction, according to an example;

FIG. 4C is a depiction of the distribution for homography parameters for a simulated rolling shutter after Gaussian smoothing between blocks for use in a method for image distortion correction, according to an example; and,

FIG. 5 is a figure depicting the inverse warping transform of an image, for use in a method for image distortion correction, according to an example

### DETAILED DESCRIPTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices. Unless specifically stated otherwise, as apparent from the following discussions, it is appreciated that throughout the specification discussions utilizing terms such as “obtaining”, “determining”, “comparing” or the like, include actions and/or processes of a computer processor that manipulate and/or transform data into other data, said data represented as physical quantities, e.g. such as electronic quantities, and/or said data representing the physical objects.

The term “processor” or the like should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, one or more non-transitory computer-readable media storing computer-readable instructions that, when executed by a processor operatively coupled to a media, cause the processor to perform actions, and other media such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

The operations in accordance with the teachings herein may be performed by a computer specially constructed for the desired purposes or by a general purpose computer specially configured for the desired purpose by a computer program stored in a computer readable storage medium.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

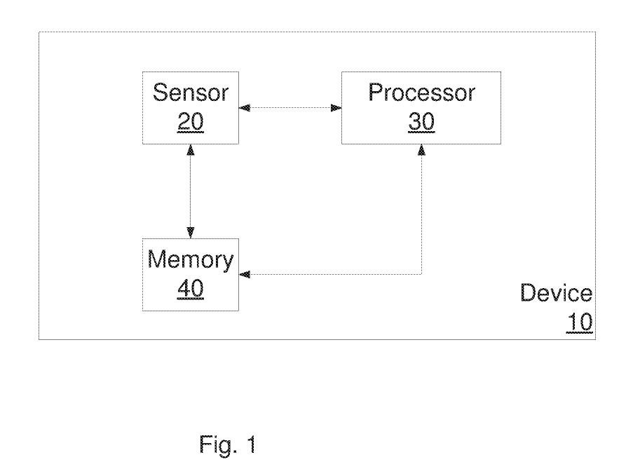

FIG. 1 is a schematic of a device with an image sensor, for use in image distortion correction, according to an example.

In some examples a device 10 includes an image sensor 20. Device 10 can be a camera, a Smartphone, a portable device, a vehicle, an unmanned aerial vehicle (UAV) a hand held device, a fixed position device and/or other apparatus.

In some examples device 10 can be a camera that has a known, predictable and/or unpredictable high frequency vibration such as a missile.

Image sensor 20 can include an active pixel sensor (APS). The APS may include an integrated circuit. The integrated circuit can include an array of pixel sensors, wherein each pixel is a photo-detector and/or and active amplifier.

The APS can use a complementary metal-oxide-semiconductor (CMOS) technology. A CMOS pixel can include a photodetector, e.g., a pinned photodiode, a floating diffusion, a selection gate, a reset gate, a transfer gate, and other components. The pixels within a CMOS image sensor can include a two dimensional array of pixels wherein the array contains rows and columns of pixels.

The image sensor can include charge-coupled device (CCD) image sensors.

Device 10 can be configured to capture still and/or motion images. The still and or motion images can be captured digitally. Device 10 may be a camera configurable to move and/or pan quickly and/or to vibrate in one or more directions. Device 10 may include a camera configured to capture images of fast moving things.

Device 10 may be a camera configured to capture sets of images, such as movies. Device 10 can include camera components such as lenses, mirrors, sights, viewfinders, LCD screens, flashes, one or more sensors such as infrared sensors, shutters, power supplies, components for inputs, components for outputs, and other components of cameras.

Device 10 can include a processor 30. Processor 30 may process images from image sensor 20. Processor 20 may warp, transform and/or otherwise modify images and/or data associated with image sensor 20.

Memory 40 may locally store information, data, and/or images associated with device 10, image sensor 20 and/or other components of device 10.

Device 10 may have other components and device 10 and/or components therein may be in wired and/or wireless communication with other components associated with device 10.

Device 10 may have sensors configured to calculate and retain data related to camera shake and camera motion.

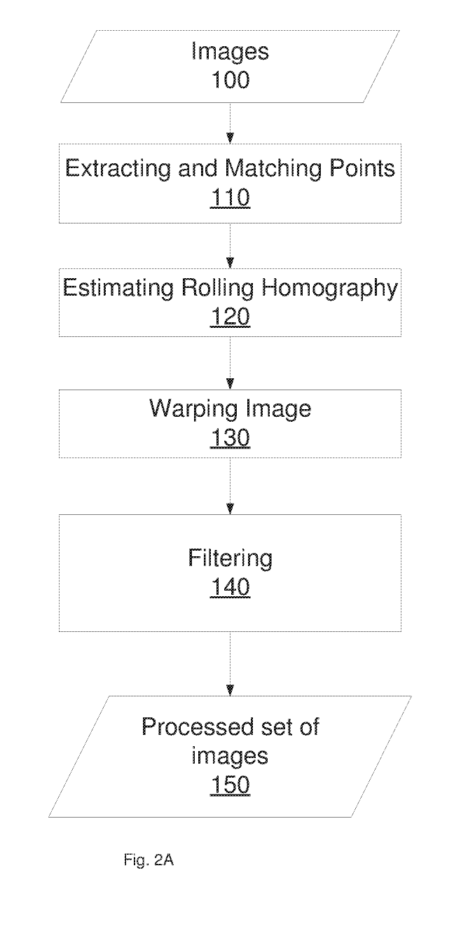

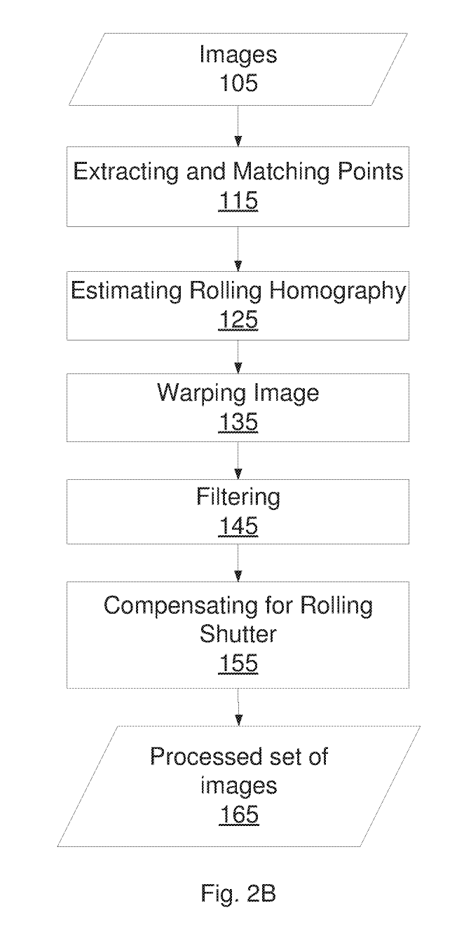

FIG. 2A is a flowchart illustrating a method for image distortion correction, according to an example

In some examples, a visual distortion in an image or a set of images may be the result of a digital process. In some examples a visual distortion may be the result of a mechanical process. In some examples a visual distortion may be the result of a combined mechanical and digital process.

In some examples a camera may capture one or a series of images, the one or series of images may be distorted due to for example, a rolling shutter effect on the sensor of said camera. The distortion may be exacerbated, worsened or otherwise changed due to mechanical factors such as camera shake.

A camera, for example the device described above may be used to capture a plurality of images, the captured images stored in memory, the memory as described for example above. The plurality of images may be part of a set of images. Information regarding the device may be known, for example information regarding one or more sensors for image capture, information regarding other sensors, information regarding the environment wherein the images were captured, information regarding one or more frequencies that can represent camera shake, and other information.

A first step can include a processor, for example as described above and/or other processors, for example in post processing of an image, accepting as an input, the plurality of images, for example, set of images as depicted as data set 100.

The plurality of images may be a series of images and/or frames that may represent a film, movie, motion picture or other compilation of images. The plurality of images may have been acquired via a CMOS sensor within a camera. The plurality of images may be a color movie taken from a vibrating CMOS color camera with a rolling shutter. In some examples, as a threshold value for correcting image distortion, the movie may include movement within the individual frames of the set of images a maximum amount of moving objects. This maximum may be determinable in relation to the area of the frame of said image, and/or may be determinable as a function of the number of discretely defined objects in the image, where discretely defined objects may represent objects that move independent of their surroundings.

In some examples, said threshold may be up to 10% of the image, for example, between 20 and 60 moving, objects, for example, 40 moving objects.

In some examples, the movie may include images that include the presence of a body of water, an expanse of sky, or other monotonous imagery, such as roads, walls, indistinguishable vegetation and or other imagery within the field of view as represented in the image and or of one or more images. There may be a threshold value of a minimum and/or maximum amount of monotonous imagery per image within a set of images. For example, this threshold may be at most between 20% and 90% of a frame for each image, for example, at most 60% of the frame of the image.

In some examples the images may be represented by one or more pixels within a frame. Said pixel may be a picture element, for example the smallest addressable element within said image. The pixel may be the smallest controllable element within the image. The pixel may have a color intensity associated with the pixel. The pixels may be divisible into fractions of pixels.

The set of the total number of pixels in the frame may be divisible into groups, for example discrete and/or overlapping groups. Groups of pixels can include a one or more vertical row of pixels, e.g., a plurality or pluralities of pixel rows, spanning the length of the frame of the image. Groups of pixels can include a horizontal column of pixels spanning the height of the frame of the image. The height of a frame and/or the length of the frame may be relative to the image presented on the frame, wherein the height and length are in reference to the orientation of the image within the frame. In some examples, rows of pixels may correspond to rows in a rolling shutter, irrespective of the orientation of the image within the frame.

Row and/or columns of pixels can be grouped into larger groups of pixels, for example, a set of rows of pixels.

The plurality of images, for example from a movie comprising frames of images, can comprise consecutive images, for example, temporally consecutive images. In some examples, a pair of consecutive images are matched, registered, and/or otherwise compared vis-à-vis each other, as described, for example, in box 110, resulting in a registered pair of images; e.g., wherein a registered pair of images represents, a pair of images with matching corresponding pixels, and/or other segments, portions or parts thereof, but not yet necessarily transforming the image in light of those matched pixels,

Said registered pair of images may be registered based on one or more pixels and/or landmarks within each of the images in the image pair. Said registered pair of images may be registered based on a majority of pixels within each of the images within each image pair. In some examples said registered pair of images may be registered by one or more algorithms. Said one or more algorithms may be robust such that not all pixels need match within the registered pair of images. Said one or more algorithms may be robust such that one image may have more pixels than the other image.

The methods described herein for registering pairs of images can be used for all images within a movie or within a set of images. The methods described herein for registering pairs of images can be used for a fraction of the images within a movie or a set of images.

The consecutive images can be matched by algorithms that, for example, match image corners globally and reject outliers. In some examples, these and/or other matching methods are used to match a first and a second consecutive image.

In some examples, matching two or more consecutive frames within a consecutive sequence of images can include dividing the frame of the first image into a grid of bins and dividing the frame of the second image into a corresponding grid of bins. Where each bin in a first image in a set of consecutive images corresponds to a bin in a second image in a set of consecutive images. These corresponding bins in the first image and paired bin in the second image make a bin pair. In some examples, the grid may be a grid of between 5 and 20 bins on the vertical axis and 5 and 20 bins on the horizontal axis. In some examples, the grid may be a grid of 16 bins on the vertical axis and 16 bins on the horizontal axis.

For each bin in the grid, corners of objects within the bin can be determined and matched via one or more algorithms or methods to a corresponding bin in a second consecutive image.

For each bin in the grid, features within said bin can be matched via one or more algorithms or methods with features within said corresponding bin in a second consecutive image.

In some examples, the features, points of interest and/or locations within each bin in the first image within an image pair of consecutive images can be matched to a corresponding feature, point of interest and/or location within the second image within an image pair of consecutive images. The matching can include one or more algorithms or methods, including for example feature tracking algorithms.

For each bin in the grid, outliers can be rejected from a matching algorithm. In some examples, an algorithm or method, for example, Random Sample Consensus (RANSAC) can be used to reject outliers.

In some examples, a projective transformation to describe a relationship between corresponding bins can be estimated robustly. Pixels within said corresponding bins that deviate by more than a threshold from a consensus model can be rejected. In some examples, the threshold can be a shift of between 0.1 and 10 pixels, for example 1 pixel from the estimated location of said pixel, based for example on the location of the corresponding pixel.

In some examples, the matching points representing, for example, corners of objects within each bin, within each bin pair can be combined to create a global list of paired points for each set of consecutive images. In some examples, other matching pairs of points can be added to said global list.

Registered and/or matched pairs of consecutive images can be analyzed to find a projective transformation that describes the transform between the first and second images in an image pair, as depicted, for example in box 120.

In the projective transform, e.g., mapping between any two projection planes with the same center of projection, for example a linear projective transformation, the transform of each point, pixel and/or other feature on the first image within the image pair (x₁, y1) and (x₂, y2), where x and y are the x, y coordinates of the pixel, point or feature.

A planar homography matrix, where the two-dimensional coordinate is represented by a homogenous coordinate, i.e., three values, an x value, a y value and a third coordinate, w, for example. The matrix, can represent, for example, a projective mapping of image points from the first image to the second according to the linear projective equation:

$$[ \begin{matrix}{x}_{2} \\ {y}_{2} \\ w\end{matrix} ] = [ \begin{matrix}{h}_{1 , 1} & {h}_{1 , 2} & {h}_{1 , 3} \\ {h}_{2 , 1} & {h}_{2 , 2} & {h}_{2 , 3} \\ {h}_{3 , 1} & {h}_{3 , 2} & {h}_{3 , 3}\end{matrix} ] \cdot [ \begin{matrix}{x}_{1} \\ {x}_{2} \\ 1\end{matrix} ]$$

Where,

$${x}_{2} = \frac{{h}_{1 , 1} {x}_{1} + {h}_{1 , 2} {y}_{1} + {h}_{1 , 3}}{{h}_{3 , 1} {x}_{1} + {h}_{3 , 2} {y}_{1} + {h}_{3 , 3}} ,$$

and

Where,

$${y}_{2} = \frac{{h}_{2 , 1} {x}_{1} + {h}_{2 , 2} {y}_{1} + {h}_{2 , 3}}{{h}_{3 , 1} {x}_{1} + {h}_{3 , 2} {y}_{1} + {h}_{3 , 3}}$$

And where, the homogeneous component of a coordinate vector (normally called w) will likely not be altered. One can therefore value it as 1 and ignore it.

The values within the planar homography matrix can be estimated given the known coordinates, for example using MATLAB. In some examples, the first image and the second image in an image pair may be distorted by one or more effects, for example via a rolling shutter.

In examples where images are distorted by a rolling shutter, pixels across a scan line of the image, for example, the scan lines described above, will share the same, similar or nearly similar transformation between a first and second image within an image set.

The transformation may be described, characterized or otherwise defined by a parametric model. The parametric model may be generated by a processor. The generated parametric model may be a homography model, a rolling homography model, a rolling homography estimation, and/or other parametric models.

The parametric model may be generated, respectively, for each scan line of for a set of scan lines or for a set of pixel rows.

With this assumption, for each scan line, a global homography that represents the transform for all pixel within that scan line can be estimated. This homography may be different for different scan lines. The estimation of homography is, for examples, as depicted in box 120.

In some examples, a more robust method may include an estimated homography for a block of rows, a set of rows, and/or other combinations of pixels and/or rows of pixels. In some examples, a block of rows may overlap with other blocks of rows. In some examples, a block of rows may contain between 1 to 20 scan lines where a scan line can include rows of pixels, wherein the height of the scan lines may be one or more pixels.

In some examples, an image and its corresponding image in a set of consecutive images, within a set of images, may be portioned into blocks. For example, the images may be divided into M blocks of rows of pixels where M can be from 5 to 75 blocks, for example, 50 blocks.

Hₖ homographies can be solved for each of the M blocks, wherein each of the M blocks are overlapped with neighboring blocks. The method may be configured to smoothly interpolate homographies using for example, convolving the blocks with a Gaussian function, e.g., Gaussian weighting, smoothing, blurring or other functions and/or other methods.

The M blocks may be overlapping with neighboring blocks. In some examples between 10 and 50 rows of pixels are overlapped between blocks within the M blocks. In some examples 30 rows of pixels are overlapped between the M blocks.

In the Gaussian smoothing, the standard deviation of the distribution may be between 1 and 20 e.g., σ=5.

Where the Gaussian distribution,

$$G = ( x ) = \frac{1}{\sqrt{2 πσ}} {e}^{- \frac{{x}^{2}}{2 {σ}^{2}}} .$$

For every row of pixels, X in block M, the homography H_{X} can be described as

H_{X}=Σ_{K=1}^{M}HₖWₖ(X).

Where W is a Gaussian weight centered around the middle of each strip of scan lines

In some examples, robustness to non-informative regions may be improved, wherein non informative regions can be monotonous or near monotonous regions, for example sea and sky for example, as described above.

Filtering non-informative blocks, and/or non-informative transformations can be done an according to the following conditions:

1. The transformed plane is facing the opposite direction; or,

2. The strip corners are moved more than half of the strip size; or,

3. Less than a threshold, for example between 10 and 50%, e.g., 30% of detected points in a current block were declared by RANSAC, and or other algorithms as matching inlier pairs.

Using an inverse warping transform sets of a plurality of pixel rows are warped based on the calculated homography, described for example, above. These warped sets of plurality of pixel rows can compensate for local image distortion within the set of the plurality of pixel rows. In some examples, a warping may be conducted for every pixel, point or portion of the image. In some examples, an inverse warping transform may be conducted for each row. In some examples, a row within a second image within a consecutive image set may be inversely transformed to fit a row within a first image within a consecutive image set. The image warping as depicted in block 130.

In some examples the warping is iterative in nature wherein pixels and or other parts within sets of a plurality of pixel rows are warped based on the calculated homography iteratively from later frames or images within an image set or film to earlier frames or images within an image set or film. This process may be applied iteratively until all the frames or images within an image set or film have been warped back with relation to the first or an earlier frame or image within a set of images or film.

After an image warping, one or more temporal filters can be applied for each pixel in each image. The temporal filter, as depicted in box 140, may be applied to overcome residual rolling shutter jitter.

A temporal filter can be configured such that corresponding pixels within a buffer set of images are penalized if they differ much from a current corresponding pixel, according to the following equation:

$$W ( x , y , k ) = \frac{\frac{1}{k} exp ( \frac{{( {I}_{buff} ( x , y , k ) - {I}_{Curr} ( x , y ) )}^{2}}{2 {σ}^{2}} )}{{\sum }_{k = 1}^{N} \frac{1}{k} exp \frac{{( {I}_{buff} ( x , y , k ) - {I}_{Curr} ( x , y ) )}^{2}}{2 {σ}^{2}}}$$

Where σ²=7.5 gray level.

Where W(x,y,k) is a weighting factor for a pixel (x,y) in frame k

Where I_{buff} (x,y,k) is a buffer of N frames from current frame and N−1 frames backward

Where I_{curr} (x,y) is the current frame

The exponential component (i.e., exp) can result in a weighting whereby Pixels that do not differ substantially with their corresponding pixels are associated with higher weight values.

In some examples, a buffer of images can be from 2 to 50 images, for example, 20 images.

A final set of images can be outputted, the set of images processed such that effects of the rolling shutter of a camera are minimized, as depicted in block 150.

FIG. 2B is a flowchart illustrating a method for image distortion correction, including rolling shutter, according to an example.

In some examples, a visual distortion in an image or a set of images may be the result of a digital process. In some examples a visual distortion may be the result of a mechanical process. In some examples a visual distortion may be the result of a combined mechanical and digital process.

In some examples a camera may capture one or a series of images, the one or series of images may be distorted due to for example, a rolling shutter effect on the sensor of said camera. The distortion may be exacerbated, worsened or otherwise changed due to mechanical factors such as camera shake.

A rolling shutter effect may be the result from not all the frame of an image being recorded at the same time. A CMOS sensor may be configured to include a rolling shutter for practical reasons. In a rolling shutter CMOS sensor, the CMOS sensors may be configured to capture a frame of an image and/or set of images, the capture occurring one scan line at a time, with a lag between the capture of each scan line. The lag between scan line capotes may be imperceptible to a human observer.

In some examples, a method for compensating for image sensor related distortions, such as, for example, rolling shutter effects, may include the following steps.

A camera, for example the device described above may be used to capture a plurality of images, the captured images stored in memory. A first step can include a processor, for example as described above and/or other processors, for example in post processing of an image, accepting as an input, the plurality of images, for example, set of images as depicted as data set 105.

The plurality of images may be a series of images and/or frames that may represent a film, movie, motion picture or other compilation of images. The plurality of images may have been acquired via a CMOS sensor within a camera. The plurality of images may be a color movie taken from a vibrating CMOS color camera with a rolling shutter. In some examples, as a threshold value for correcting image distortion, the movie may include movement within the individual frames of the set of images a maximum amount of moving objects, this threshold for example, as described above with reference to FIG. 2A.

In some examples, the movie may include images that include the presence of a body of water, an expanse of sky, or other monotonous imagery, for example, as described above with reference to FIG. 2A.

In some examples the images may be represented by one or more pixels within a frame, for example, as described above with reference to FIG. 2A.

The set of the total number of pixels in the frame may be divisible into groups for example, as described above with reference to FIG. 2A.

Row and/or columns of pixels can be grouped into larger groups of pixels, for example, a set of rows of pixels, for example, as described above with reference to FIG. 2A.

The plurality of images, for example from a movie comprising frames of images, can comprise consecutive images, for example, temporally consecutive images. In some examples, a pair of consecutive images are matched, registered, and/or otherwise compared vis-à-vis each other, as described, for example, in box 1115, resulting in a registered pair of images, for example, as described above with reference to FIG. 2A.

Said registered pair of images may be registered based on one or more pixels and/or landmarks within each of the images in the image pair, for example, as described above with reference to FIG. 2A.

The methods described herein for registering pairs of images can be used for all images within a movie or within a set of images. The methods described herein for registering pairs of images can be used for a fraction of the images within a movie or a set of images.

The consecutive images can be matched by algorithms that, for example, match image corners globally and reject outliers. In some examples, these and/or other matching methods are used to match a first and a second consecutive image.

In some examples, matching two or more consecutive frames within a consecutive sequence of images can include dividing the frame of the first image into a grid of bins and dividing the frame of the second image into a corresponding grid of bins for example, as described above with reference to FIG. 2A.

In some examples, a projective transformation to describe a relationship between corresponding bins can be estimated robustly, for example, as described above with reference to FIG. 2A.

In some examples, the matching points representing, for example, corners of objects within each bin, within each bin pair can be combined to create a global list of paired points for each set of consecutive images. In some examples, other matching pairs of points can be added to said global list.

Registered and/or matched pairs of consecutive images can be analyzed to find a projective transformation that describes the transform between the first and second images in an image pair, as depicted, for example in box 125.

A planar homography matrix, where the two-dimensional coordinate is represented by a homogenous coordinate, i.e., three values, an x value, a y value and a third coordinate, w, for example. The matrix can represent, for example, a projective mapping of image points from the first image to the second according to the linear projective equation for example, as described above with reference to FIG. 2A.

In examples where images are distorted by a rolling shutter, pixels across a scan line of the image, for example, the scan lines described above, will share the same, similar or nearly similar transformation between a first and second image within an image set.

The transformation may be described, characterized or otherwise defined by a parametric model. The parametric model may be generated by a processor. The generated parametric model may be a homography model, a rolling homography model and/or other parametric models. Parametric model may be generated for corresponding pixels, sets of pixels, rows, fractions of rows, groups of rows, sets of rows, images, fractions of images or other corresponding parts of sets of images. The respective generated parametric models for use in warping said corresponding parts of sets of images.

With this assumption, for each scan line, a global homography that represents the transform for all pixel within that scan line can be estimated. This homography may be different for different scan lines. The estimation of homography is, for examples, as depicted in box 125.

In some examples, a more robust method may include an estimated homography for a block of rows, a set of rows, and/or other combinations of pixels and/or rows of pixels, for example, as described above with reference to FIG. 2A.

Hₖ homographies can be solved for each of the M blocks, for example, as described above with reference to FIG. 2A.

The method may be configured to smoothly interpolate homographies using for example, convolving the blocks with a Gaussian function, e.g., Gaussian weighting, smoothing, blurring or other functions and/or other methods, for example, as described above with reference to FIG. 2A.

In some examples, robustness to non-informative regions may be improved, wherein non informative regions can be monotonous or near monotonous regions, for example, sea and sky for example, as described above.

Filtering non-informative blocks, and/or non-informative transformations can be done for example, as described above with reference to FIG. 2A.

Using an inverse warping transform rows of pixels are warped based on the calculated homography, described for example, above. In some examples, a warping may be conducted for every pixel, point or portion of the image. In some examples, an inverse warping transform may be conducted for each row. In some examples, a row within a second image within a consecutive image set may be inversely transformed to fit a row within a first image within a consecutive image set. The image warping as depicted in block 135.

After an image warping, one or more temporal filters can be applied for each pixel in each image. The temporal filter, as depicted in box 145, may be applied to overcome residual rolling shutter jitter.

A temporal filter can be configured for example, as described above with reference to FIG. 2A.

Rolling shutter can be compensated for by use of the above methods, and in some examples, via additional related or similar algorithms, the compensation of the rolling shutter for example, as depicted in block 155.

One the rolling shutter and other image distortions have been corrected and/or changed, and/or modified, and/or compensated, the resulting set of images is a process set of images, for example as depicted by dataset 165.

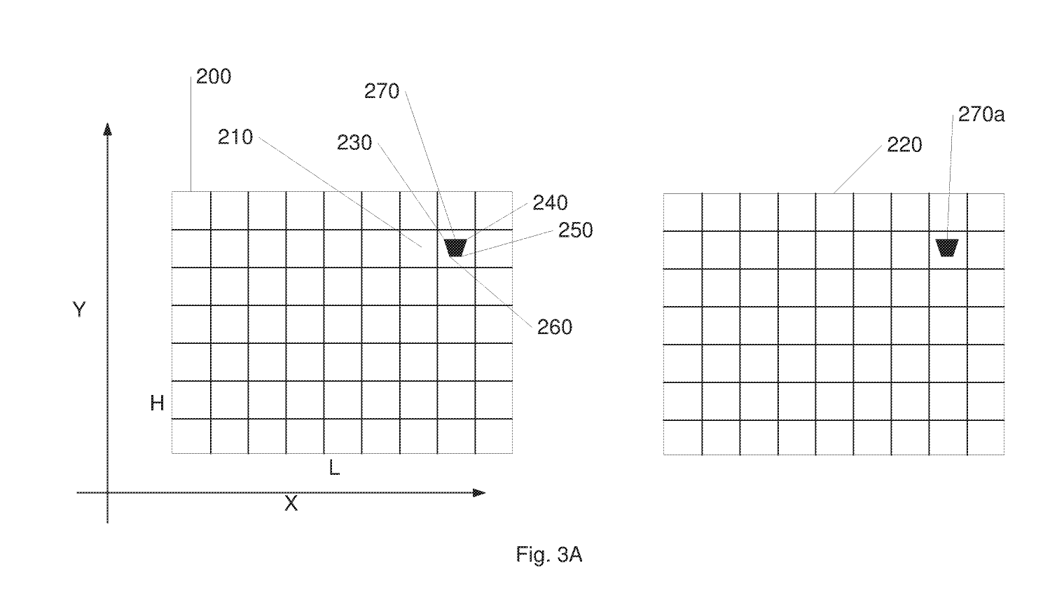

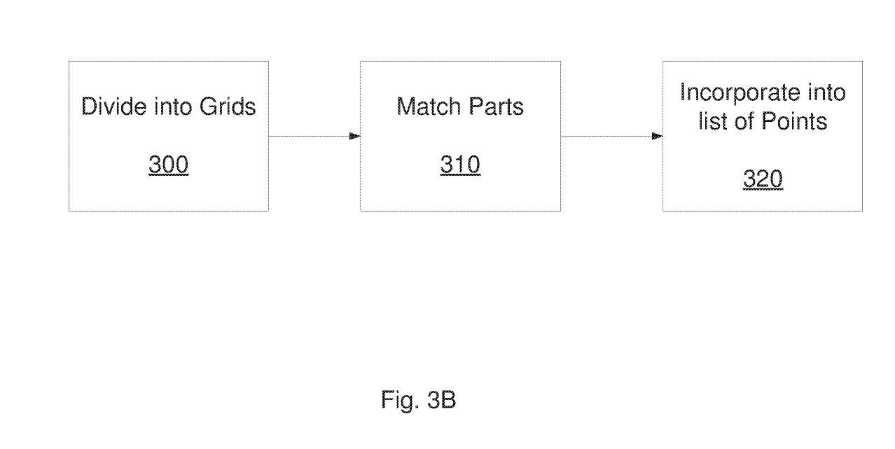

FIG. 3A depicts a matching between two images, for image distortion correction, according to an example.

A frame or image within a set of frames and images can be as described above. Frame 200 can be divided into a grid, with gridlines xᵢ and yᵢ. The frame can be divided into an even number of bins 210, along, for example the grid lines. The frame can be divided into a grid of 16 by 16 bins. In some examples the bins are of equal size. In some examples bins 210 are not of equal size. In some examples there are an equal number of bins along the length L of frame 200 as there are along height H of frame 200. In some examples there are a different number of bins along the length L of frame 200 as there are along height H of frame 200.

In some examples each bin 210 is a polygon, for example, a rectangle. In some examples, each bin 210 is a square.

In some examples, a first and second frame 200, e.g., frame 200 and frame 220, can have corresponding bins 210. In some examples, not all bins 210 correspond between frames 200 and 220. In some examples, for each bin one or more algorithms are employed to determine and/or detect the corners of object within said bin. In some examples not all bins have objects with their corners detected.

In some examples one or more algorithms are employed to match features in corresponding bins 210. In some examples, there are thresholds for determining which features are matched and which features are not matched between two corresponding bins.

In some examples corners, e.g., corners 230, 240, 250 and 260 of corresponding objects within bins in the first frame 200 and second frame 220 are detected via one or more algorithms. In some examples, the algorithm can be Shi & Tomasi's eigenvalue method.

In some examples, one or more algorithms can be employed such that detected corners of an object within a bin, e.g., 230, 240, 250 and 260 of object 270 in the first frame 200 and corresponding object 270a in second frame 220 match up.

Object 270 and/or object 270a do not necessarily need to reside wholly within a single bin in either one or both of the corresponding images.

In some examples one or more separate or the same detectors can be applied to each bin. In some examples, the application of separate detectors for each bin may be allow for adaptive threshold selection with respect to local textures. In some examples, the application of separate detectors for each bin may allow for informative features to be detected even on low textured regions, for example, monotonous or nearly monotonous regions such as blacktop, sea or sky.

In some examples, local outliers are rejected, locally, within each bin, for example by using one or more algorithms such as RANSAC. In some examples, rejecting outliers locally can allow for the efficient rejection of outliers without necessarily making strong model assumptions.

FIG. 3B depicts a flowchart describing matching between two images, for image distortion correction, according to an example.

An image or a frame, for example, the images or frames described above are part of a set of images or frames comprising at least a first and second image, the first and second image ordered consecutively.

The first and second images are divided into grids, for example, as described above and as depicted in box 300. In some examples, the first and second images are divided into grids comprising bins of equal size.

For each bin in the first image, parts thereof can be matched with parts thereof in the second image, as depicted in box 310. In some examples the matching of parts can include corner detection, for example, as described above, feature matching, for example, as described above, outlier rejection, for example as described above, and/or one or more algorithms for use in matching.

Points matched, for example, via one or more algorithms described above can be combined into pairs within a larger list of pairs or matching points, as depicted for example in box 320.

Points matched between frames may be shifted, for example matched and/or corresponding points from a first image can be shifted both as to their x axis and as to their y axis, relative to matched and/or corresponding points from a second image. image

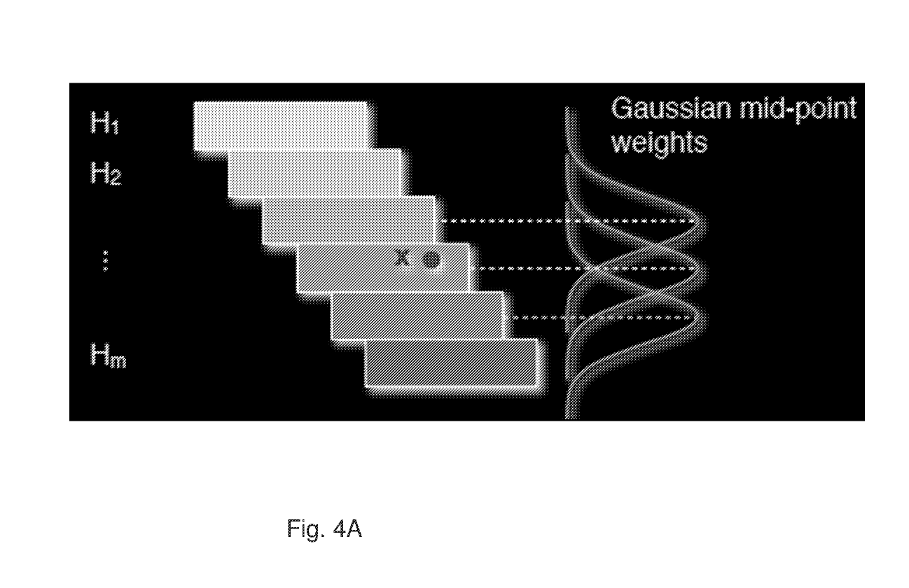

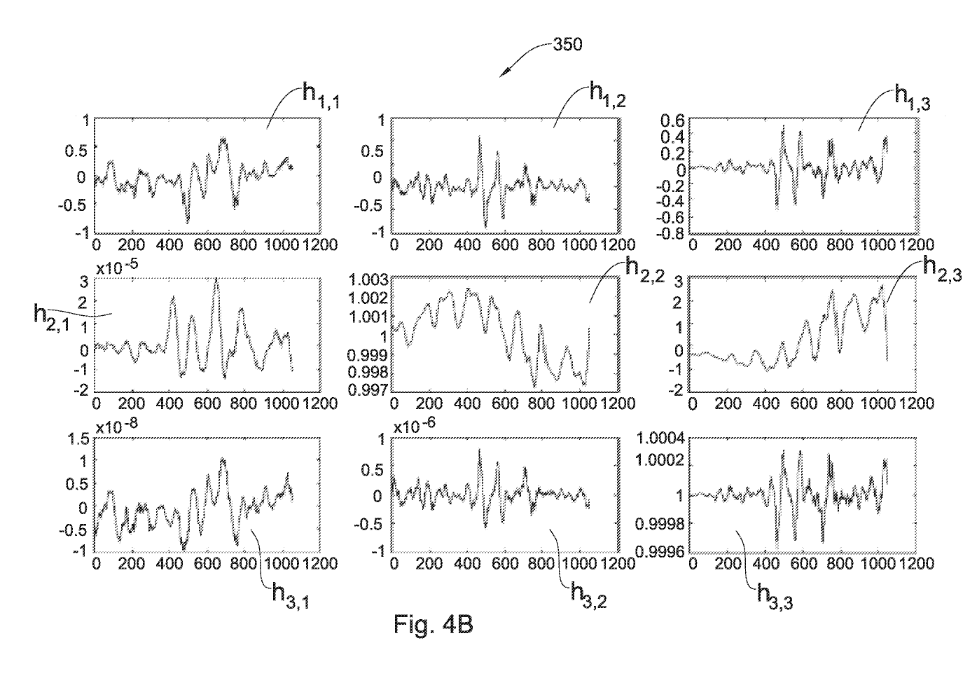

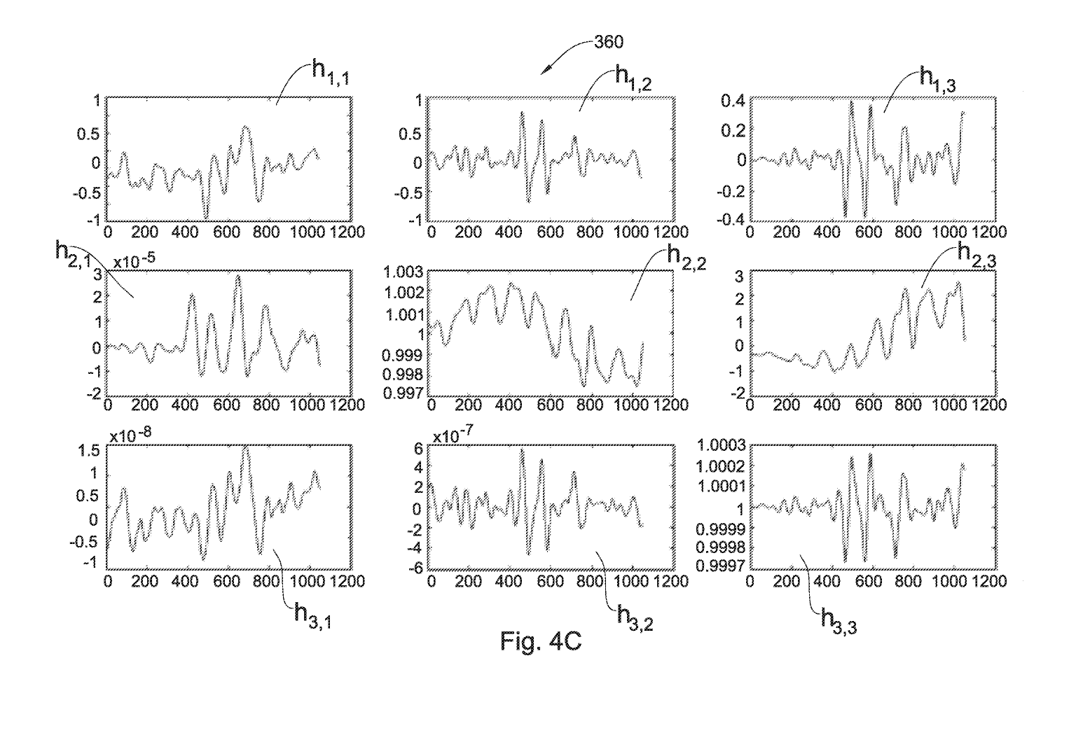

FIG. 4A is a depiction of a smoothing of homographies, for use in a method for image distortion correction, according to an example

In some examples, a frame or image, for example as described above, can be portioned into rows of pixels. The image can be portioned into set or blocks of rows of pixels, e.g., row M.

In some examples, a homography can be estimated for each row of pixels. In some examples, a homography can be estimated for a block of rows of pixels. The block of rows of pixels can be related to a height of a shutter aperture on an image sensor that includes a rolling shutter function. In some examples, the height of the block of rows of pixels is the height of the shutter aperture on an image sensor that includes a rolling shutter function. In some examples the height of the block of rows of pixels can be related to the necessary number of homography values to compensate for the rolling shutter. In some examples the height of the block of pixels may be determined such that there are between 10 and 100 equally sized blocks along the height of an image. In some examples there may be 20 equally sized blocks of rows of pixels.

In some examples there may be 50 equally sized blocks of rolling pixels. In some examples, the blocks of rows of pixels may be overlapping. In some examples the blocks of rows of pixels may be overlapping by 0-50 rows of pixels for each block. In some examples, they may be overlapping by 30 pixels per block.

In some examples one or more smoothing algorithms are applied to the homographies of each block. In some examples a Gaussian smoothing is applied. In some examples, said Gaussian smoothing is applied such that is smoothly interpolates the homographies of the overlapping blocks of rows of pixels.

FIG. 4B is a depiction of the distribution for homography parameters for a simulated rolling shutter prior to Gaussian smoothing between blocks for use in a method for image distortion correction, according to an example;

This figure represents the distribution for homography parameters for a simulated rolling shutter prior to Gaussian smoothing between blocks. The CMOS sensor in the simulated rolling shutter is configured such that is experiencing vibration only in the y axis.

Box 350 depicts examples of homography values (on the y axis) for each frame (on the x axis), prior to Gaussian smoothing. Each frame is a frame from within a set of frames or images, for example a movie or film, for example, as described above.

Each of the 9 graphs in box 350 represent one of the values in the planar homography matrix, the planer homography matrix, for example, as described above. As depicted herein, the upper right graph represents the value h_{1,1} from the planar homography matrix and the bottom left most graph represents the value h, _{3.3}. The other values correspond as depicted.

The planar homography matrix, as represented by the 9 graphs in box 350 represents a homography for a block of rows, for example, the homography for set or block of rows M as described above.

FIG. 4C is a depiction of the distribution for homography parameters for a simulated rolling shutter after Gaussian smoothing between blocks for use in a method for image distortion correction, according to an example

Box 360 depicts an example of a homography data relating to overlapping blocks of rows after Gaussian smoothing. As described, for example above, each of the graphs represent one of values in the planar homography matrix, with the y axis representing the h value and the x axis representing a frame within a set of frames or images, for example a movie or film.

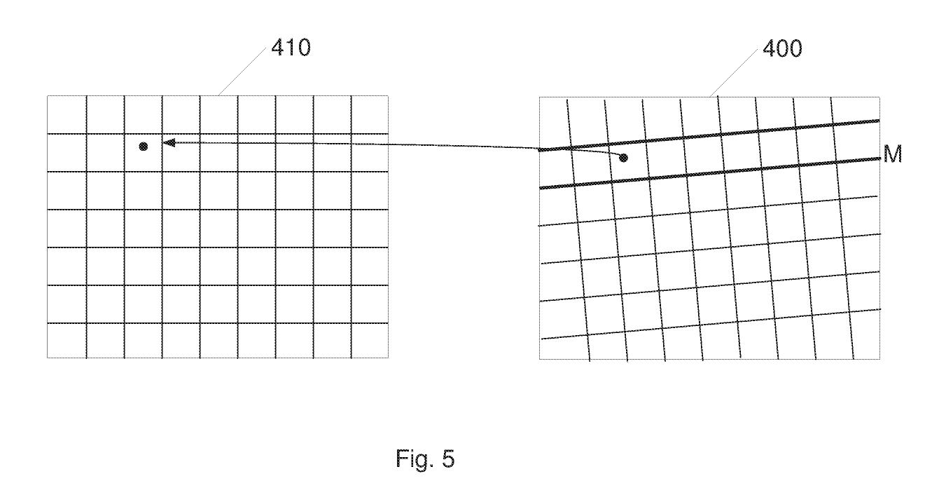

FIG. 5 is a depiction of image warping, for use in a method to for image distortion correction, according to an example.

In some examples a first image or frame and second image or frame within a set of images or frames, for example, a video are compared.

In some examples, a second frame 400 is warped to fit the previous frame 410.

In some examples, a row of pixels or a set of rows of pixels M within a second frame 400 are warped homogenously or nearly homogenously. An example of a pixel is depicted as a black dot in the figure. The warping can be an inverse warping transform based on, for example, homographies calculated, for example, as described above.

In some examples the row of pixels or sets of rows of pixels may correspond to scan lines of the sensor. For example, the row of pixels or sets of rows of pixels may correspond to the aperture of the shutter for the sensor, where the sensor employs a rolling shutter. In some examples, the nature of the set of rows of pixels may be related to the platform associated with an image sensor. In some examples the nature of the set of rows of pixels may be related to a priori date regarding the frequency of movement of the sensor.

In some examples the nature of the set of rows of pixels may be related to a priori date regarding frame rate of the set of frames. In some examples each frame within a set of frames is inversely warped such that all subsequent frames are warped to fit an initial frame within a set of frames.

It is to be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

It is also to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of processing images in a registered pair of images stored in a memory, each image comprising rows, the method comprising:
using a processor operatively coupled to the memory for:
obtaining at least one set of a plurality of pixel rows in a first image and a corresponding at least one set of a plurality of pixel rows in a second image;
generating a parametric model characterizing a transformation between pixels in the at least one set of the plurality of pixel rows in the first image with pixels in the corresponding at least one set of a plurality of pixel rows of the second image; and,
warping the set of the plurality of pixel rows in the second image with respect to the set of the plurality of pixel rows in the first image using the generated parametric model, thereby compensating for distortions between the corresponding sets of the pluralities of pixel rows.

2. The method of claim 1, further using the processor to divide each image in the registered pair of images into pairs of corresponding overlapping sets, each set comprising a plurality of pixel rows.

3. The method of claim 2, further using the processor for generating, for each pair of corresponding overlapping sets, a parametric model characterizing a transformation between pixels in the corresponding sets; and for warping each set of pixel rows in the second image with respect to a corresponding set of pixel rows in the first image using a respective generated parametric model, thereby compensating for distortions between the registered pair of images.

4. (canceled)

5. The method of claim 2, further using the processor to smoothly interpolate one or more of the corresponding overlapping sets.

6. The method of claim 1, further using the processor to apply a temporal filter to each pixel in the warped set of the plurality of pixel rows.

7. The method of claim 1, further using the processor for registering the pair of images, wherein registering the pair of images comprises dividing the first image into a grid of equally sized bins and registering each equally sized bin separately with its corresponding bin in a similarly divided second image.

8. The method of claim 7 further using the processor for registering each bin separately, by, for each bin and its corresponding bin, detecting and matching corners and features and rejecting local outliers.

9. The method of claim 1, wherein generating a parametric model characterizing a transformation between pixels includes generating a rolling homography estimation.

10. The method of claim 1 wherein non-informative transformations are filtered out.

11. A non-transitory computer-readable media storing computer-readable instructions that, when executed by a processor operatively coupled to a media, cause the processor:
to process images in a registered pair of images stored in a memory, each image comprising pixel rows;
to obtain at least one set comprising a plurality of pixel rows in a first image and a corresponding at least one set comprising a plurality of pixel rows in a second image;
to generate a parametric model characterizing a transformation between pixels in the at least one set of the plurality of pixel rows in the first image with pixels in the corresponding at least one set of a plurality of pixel rows of the second image; and,
to warp the set comprising a plurality of pixel rows in the second image with respect to the set comprising a plurality of pixel rows in the first image using the generated parametric model, thereby compensating for distortions between the corresponding sets of the pixel rows.

12-20. (canceled)

21. A system capable of processing a registered set of images comprising rows of pixels, the system comprising:
a processor operatively coupled to a memory, the processor configured:
to process images in a registered pair of images stored in a memory, each image comprising rows
to obtain at least one set comprising a plurality of pixel rows in a first image and a corresponding at least one set comprising a plurality of pixel rows in a second image;
to generate a parametric model characterizing a transformation between pixels in the at least one set of the plurality of pixel rows in the first image with pixels in the corresponding at least one set of a plurality of pixel rows of the second image; and,
to warp the set comprising a plurality of pixel rows in the second image with respect to the set comprising a plurality of pixel rows in the first image using the generated parametric model, thereby compensating for distortions between the corresponding sets of the pixel rows.

22. The system of claim 21, wherein the processor is further capable of dividing each image in the registered pair of images into pairs of corresponding overlapping sets, each set comprising a plurality of pixel rows.

23. The system of claim 22, wherein the processor is further capable of, for each pair of corresponding overlapping sets, generating a parametric model characterizing a transformation between pixels in the corresponding sets and warping each set of pixel rows in the second image with respect to a corresponding set of pixel rows in the first image using a respective generated parametric model, thereby compensating for distortions between the registered pair of images.

24. The system of claim 22, wherein the processor is further capable of dividing each image in the registered pair of images into pairs of corresponding overlapping sets, each set comprising a plurality of pixel rows based on parameters related to a device which captured said pairs of images.

25. The system of claim 21, wherein the processor is further capable of smoothly interpolating one or more of the corresponding overlapping sets.

26. The system of claim 21, wherein the processor is further capable of applying a temporal filter to each pixel in the warped set of the plurality of pixel rows.

27. The system of claim 21, wherein the processor is further capable of registering the set of images, wherein registering the set of images comprises dividing the first image into a grid of equally sized bins and registering each equally sized bin separately with its corresponding bin in a similarly divided second image.

28. The system of claim 27, wherein the processor is further capable of registering each bin separately, by, for each bin and its corresponding bin, detecting and matching corners and features and rejecting local outliers.

29. The system of claim 21, wherein the processor is further capable of generating a parametric model characterizing a transformation between pixels including generating a rolling homography estimation.

30. The system of claim 21, wherein the processor is further capable of filtering out non-informative transformations.

31. A method of compensating a rolling shutter effects in a plurality of images, the method comprising:
using a processor operatively coupled to a memory:
to register a pair of images from the plurality of images stored in the memory, each image comprising pixel rows;
to obtain at least one set comprising a plurality of pixel rows in a first image and a corresponding at least one set comprising a plurality of pixel rows in a second image;
to generate a parametric model characterizing a transformation between pixels in the at least one set of the plurality of pixel rows in the first image with pixels in the corresponding at least one set of a plurality of pixel rows of the second image,
to warp the set comprising a plurality of pixel rows in the second image with respect to the set comprising a plurality of pixel rows in the first image using the generated parametric model, thereby compensating for distortions between the corresponding sets of the pixel rows; and,
compensate for distortions between the corresponding set of a plurality of pixel rows, and thereby reducing one or more rolling shutter effects.
